(19) United States
(12) Patent Application Publication
(10) Pub. No.: US 2018/0279199 A1
(43) Pub. Date: Sep. 27, 2018

(54) INTERACTIVE DATA SHARING MECHANISM FOR IMPROVED USER EXPERIENCE

(71) Applicant: QUALCOMM Incorporated, San Diego, CA (US)

(72) Inventors: Vishnu Namboodiri KARAKKAD KESAVAN NAMBOODIRI, Hyderabad (IN); Chinmaya PADHY, Koraput (IN)

(21) Appl. No.: 15/470,857

(22) Filed: Mar. 27, 2017

(51) Int. Cl. H04W 40/04; H04L 29/08; H04W 84/04; H04W 88/06; H04W 76/02; H04W 48/14; H04W 48/16

(52) U.S. Cl. CPC H04W 40/04; H04L 67/28; H04W 84/045; H04W 48/16; H04W 76/02; H04W 48/14; H04W 88/06

(57) ABSTRACT

Various aspects related to enabling data sharing between devices based on various parameters associated with the devices and/or that potentially affect the quality of requested service, are described. In an aspect, a first UE receives a request for a data service from a second UE, sends a report including a set of parameters measured by the first UE to the second UE, determines whether to operate as a hotspot to provide the data service based on the set of parameters, and provides the data service upon determining to operate as the hotspot. In another aspect, a first UE is configured to send a request for a data service to a second UE, receive one or more parameters measured by the second UE, determine whether the first UE remains interested in receiving the requested data service based on the received parameters, and receive the requested data service through the second UE.

### FIELD

The present disclosure relates generally to communication devices, and more particularly, to methods and apparatus related to data sharing between communication devices with enhanced user experience.

### BACKGROUND

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often utilized when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

When mobile devices uses existing web-data sharing mechanisms, the pairing is often performed on a request basis, without consideration of device condition and/or service related parameters corresponding to the device providing the data service to the requesting device. Many such parameters associated with the service providing device and/or associated with a current condition of the service providing device may affect both the functioning of the device as well as the quality of the data service, e.g., quality of the data connection provided to the requesting device, which ultimately affects the user experience. Without due consideration of the service providing device condition and/or the parameters which may indicate the device condition and/or the quality of the data connection/requested service, allowing the data sharing between the requesting device and service providing device acting as a hotspot may be premature.

In view of the above, there is need for improved techniques that allow both the requesting device and the data service providing device to consider one or more parameters that may affect the condition of the service providing device and/or affect the quality of the requested data service and overall user experience, prior to initiating the data service sharing. It would be desirable if such improved methods and apparatus allow the parameters to be evaluated and considered both prior to and after initiating the data sharing so that both end devices may periodically assess if continued data sharing remains feasible or if such sharing should be terminated.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various features related to improving user experience while using a data sharing mechanism for data sharing between communication devices are described. Various aspects are well suited for use by data enabled communications devices which have the capability to provide and/or receive data assistance using data sharing techniques. In accordance with an aspect of some embodiments, various parameters associated with a service providing device, e.g., a communication device capable of operating as a hotspot/data service access point, are measured and shared with a data service seeking device. In various embodiments, the parameters and/or conditions that potentially affect the quality of the data connection or requested service, are considered by both the service seeking device and the device providing data service assistance, prior to initiating the data service. The parameters and/or factors affecting the data service/device condition are monitored while the data sharing between the devices occurs, and an evaluation is performed both prior to and after initiating the data sharing, e.g., periodically, to determine whether or not the data sharing should continue or be terminated, based on the measured parameters.

The parameters and/or factors that may be taken into consideration may include, for example, battery condition, possible/expected data speed; and data limit. Additional factors, e.g., related to the data service requesting device, may also be considered in some embodiments, such as the type of requested data service and/or expected amount of data transfer that may be needed for a requested type of service. For example, if a requested data service is associated with downloading a simple web-page or email, such downloading may be easily supported by the data service providing device even if the device's battery condition and/or data limit is sub-optimal, but downloading a huge multi-media file and/or supporting an graphic intensive online game may not be possible. Thus, if a data connection is established without regard to the service providing device conditions/parameters, a poor experience for a user of the service providing device may result, e.g., because of power drain/limited battery charge or data charge incurred. Moreover, starting data sharing without proper consideration of the various factors could also result in a poor experience for the data requesting device, e.g., because of poor data speed and/or termination of the service due to the battery of the hotspot being depleted.

In an aspect of the disclosure, a method, a computer-readable medium, and an apparatus are provided. The apparatus may be a first user equipment (UE), e.g., a UE capable of providing a data service to another device. In an exemplary configuration, the first UE includes a display, at least one processor and a memory coupled to the at least one processor. In one exemplary configuration, the at least one processor is configured to receive a request for a data service from a second UE, and send a report including a first set of parameters measured by the first UE to the second UE in response to the request. The at least one processor may be further configured to determine whether to operate as a hotspot to provide the data service to the second UE based on a second set of parameters measured by the first UE, and provide the data service upon determining to operate as the hotspot to provide the data service.

In another aspect of the disclosure, another exemplary method, a computer-readable medium, and an apparatus are provided. The apparatus may be a first UE, e.g., a UE seeking data assistance/service from a second UE. In an exemplary configuration, the first UE includes a display, at least one processor and a memory coupled to the at least one processor. In one exemplary configuration, the at least one processor is configured to send a request for a data service to a second UE, and receiving, in response to the request, a first report including one or more parameters measured by the second UE. The at least one processor may be further configured to determine, based on the one or more parameters, whether the first UE remains interested in receiving the requested data service, and receive the requested data service through the second UE upon determining that the first UE remains interested in receiving the requested data service.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a communication system including a plurality devices.

FIG. 2 illustrates an exemplary communication system including an access point and a plurality of communication devices implemented in accordance with an exemplary configuration.

FIG. 3 illustrates a flowchart of an exemplary method of operating an exemplary communication device, in accordance with some embodiments.

FIG. 4 is a conceptual data flow diagram illustrating the data flow between different means/components in an exemplary apparatus.

FIG. 5 is a diagram illustrating an example of a hardware implementation for an apparatus employing a processing system.

FIG. 6 illustrates a flowchart of another exemplary method of operating another exemplary communication device, in accordance with an aspect.

FIG. 7 is a conceptual data flow diagram illustrating the data flow between different means/components in another exemplary apparatus.

FIG. 8 is a diagram illustrating an example of a hardware implementation for an apparatus employing a processing system.

FIG. 9 is a flowchart illustrating one specific exemplary method of improved data sharing between communication devices.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of mobile devices will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Various aspects of the novel systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

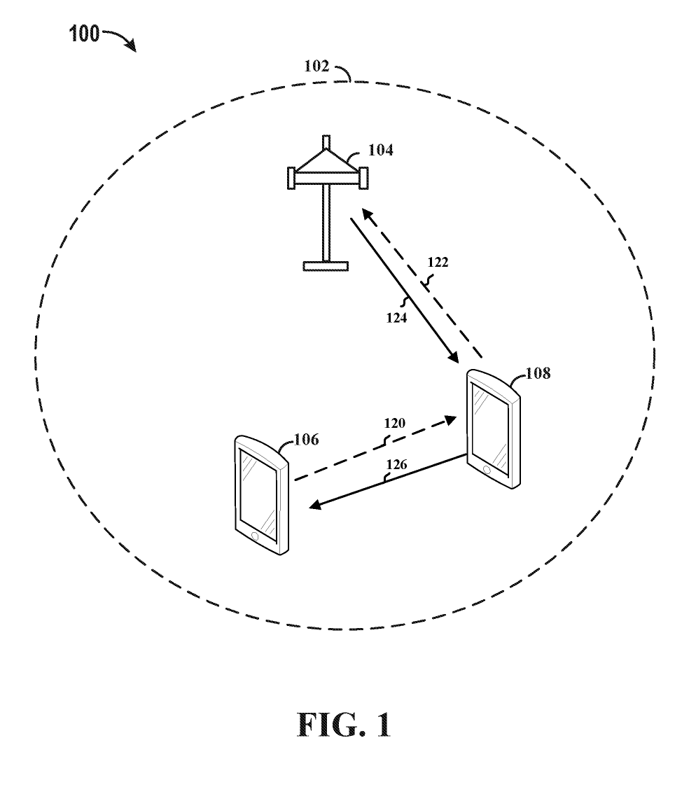

FIG. 1 shows a wireless communication system 100. The system 100 includes wireless access network 102 comprising a network base station 104 and communication devices 106 and 108. The base station 104 may communicate with the devices in the network 102 using a wireless wide area network (WWAN) wireless communication protocol. While the devices 106, 108 may communicate with the base station 104 and may seek data services though the network 102, at times a device may not be able to receive the data service directly from the network, e.g., from the base station 104. For instance, a connection between a device seeking a data service and the base station 104 may be poor, e.g., due to poor service/signal strength in the given area, and/or the data service seeking device may not have a data service subscription and/or available data capacity of the data service subscription has been reached, or the data service directly from the network base station 104 may not be available to the service seeking device for a variety of reasons. In some such events, or otherwise for other reasons, a data service seeking device may request a data service from another wireless device in the network 102 through a data sharing mechanism. The devices 106, 108 may support such a data sharing mechanism between each other such that any one of the devices 106, 108 may provide a data service to the other one. The data service may relate to, for example, web-browsing, video/audio streaming, placing and/or receiving a call, etc. In such a data sharing mechanism, one device may act as a service access point (also commonly referred to as a data/service hotspot) for the requesting device, obtain the requested data from the network 102 and forward the requested data to the requesting device.

A simple data sharing scenario is considered and illustrated in FIG. 1 where a user of the wireless device 106 requests a data service through the wireless device 108 which acts as a service access point or hotspot for the device 106. In the scenario illustrated in FIG. 1, the device 106 wants to have data connection and has a certain limitation with respect to obtaining data service from the network 102 directly through the base station 104, e.g., such as no active data plan, no network visibility, e.g., out of coverage, etc.), Accordingly, the device 106 requests (120) device 108 for assistance for the data service, e.g., request to act as a hotspot and provide the requested data service. The device 108 agrees to provide data assistance, requests (122) the data from the network base station 104, obtains (124) the requested data for the device 106 from the base station 104, and forwards (126) the data to the device 106. If the data forwarding to the requesting device 106 from the device 108 is over WiFi, the device 108 may be referred to as a WiFi hotspot for the device 106. However in this scenario the pairing is performed simply based on a request basis, without consideration of the requested service providing device condition and/or service related parameters corresponding to the service providing device 108 acting as the hotspot for the requesting device 106. Many parameters associated with the service providing device 108 and/or associated with a current condition of the service providing device 108 may affect both the functioning of the device 108 as well as the quality of the data service provided to the requesting device 106, which ultimately affects the user experience of the user of the requesting device and/or the user of the service providing device. For example, the data connection between the requesting device 106 and the service providing device 108 in the illustrated example may be established and the data sharing may be initiated without any consideration or regard to various parameters such as battery condition/charge level of the device 108 providing data assistance and serving as the hotspot, possible/expected data speed that can be supported, the data limit/data capacity associated with the device 108 and other such relevant parameters and factors.

Thus, while a data connection between the devices 106, 108 may be established and the device 108 provides (126) the requested data to the device 106, such a connection/data service, initiated without consideration of the parameters/factors of the type discussed above, could result in poor user experience for the user of device 108, e.g., because of quick power drain and/or data charge incurred. For example, the remaining battery level of the device 108 (acting as the hotspot) may be low, however if the data service and connection with the requesting device 106 is initiated without regard to the battery condition, the power drain due to providing the data service may result in the battery of device 108 being discharged quickly and/or the device 108 not being able to perform all the desired functions due to a low battery condition which is undesirable from the perspective of a user of the device 108. Often times the requested data service is associated with audio/video streaming and causes a larger power drain than a data service associated with texting and calling. Moreover such a connection/data service may result in poor user experience for the user of device 106. For example, the initiated data service/connection may quickly terminate after establishment because the device 108 may power down due to low battery, or the service may have a low data speed due to the signal conditions at the device 108 or because of a data limit being reached by the device 108 which may cause the data download speed to be throttled by the network 102. As such, a data connection/service initiated without due consideration of the parameters/factors discussed above, may result in poor overall user experience and satisfaction.

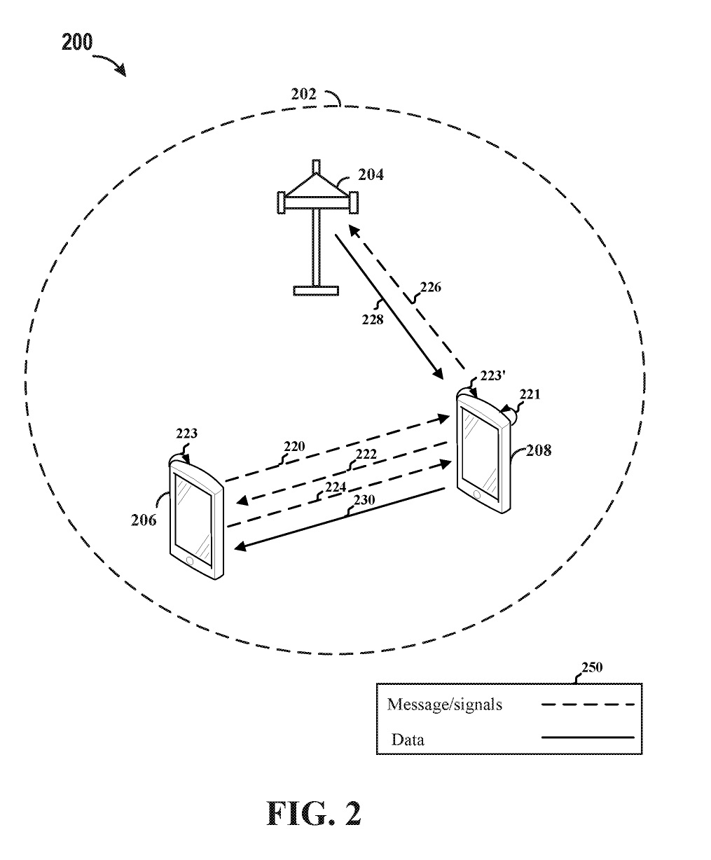

FIG. 2 shows an exemplary communication system 200 implemented in accordance with an exemplary configuration and in which aspects of the present disclosure may be employed. The system 200 includes wireless access network 202 comprising a network base station 204 and a plurality of exemplary communication devices including devices 206 and 208. The base station 204 may communicate with the communication devices in the network 202 using a wireless communication protocol. The communication system 200 may also support direct device-to-device (e.g., peer to peer) type communications between the devices 206, 208. Each of the communication devices 206, 208 may be a UE such as a smart phone, a tablet, a laptop computer, a personal computer, or the like.

In the exemplary system 200, the communication devices may support data sharing between the devices 206, 208 with additional improvements and consideration being given to the various parameters/factors that may affect the condition of the service providing device 208 and/or affect the quality of the requested data service, and overall user experience, prior to initiating the data service sharing. In accordance with an aspect, one or more such parameters may be measured by the device 208, acting as the hotspot or data service access point, and shared with the requesting device 206. In accordance with the features of the methods disclosed herein, the parameters may be considered by both the data service requesting device 206 and the service providing device 208, both prior to, and after initiating the data sharing. Thus both end devices may periodically assess if continued data sharing is feasible or determine when such sharing should be terminated. The legend 250 indicates that broken line arrows are used to indicate request/response information signals and solid lines are used to indicate data.

In the scenario illustrated in FIG. 2, the device 206 sends a request (220) to device 208 for assistance for a data service, e.g., request to act as a hotspot and provide the requested data service. In one configuration, upon receiving the request, the device 208 determines (221), e.g., by performing measurements, a set of parameters associated with the device and/or the data service that the device 208 may obtain from the network 202, which may affect the quality of the data service to be provided to the device 206 and overall user experience. In some configurations, the set of parameters measured by the device 208 includes a first parameter corresponding to a current battery condition, e.g., current battery/charge level, of the device 208, a second parameter corresponding to an expected data speed for the data service, and a third parameter corresponding to data limit for data services. The expected data speed may be measured based on a current signal strength at the device 208 e.g., with the expected data speed at a given time being estimated as proportional to the measured signal strength at the device 208 at the given time. In some configurations, the expected data speed may also be a function of a level of subscription that the device 208 may have, e.g., premium subscription with 4G or higher speeds, lower level subscription with 3G/2G speeds. While the data speed due to subscription level may not dynamically change but may be useful when the requesting device 206 considers the hotspot device 208, among other available hotspots, for the first time for providing the data service. The available data limit/capacity for data services may be the data limit, e.g., maximum allowed data that may be downloaded by the device 208 from the network 202 and/or current data balance indicating amount of data that the device 208 may download from the network 202 without exceeding allocated data limit.

In accordance with an aspect, after measuring the set of parameters, the device 208 may share the determined parameters with the data service requesting device 206 by reporting (222) the set or a subset of the determined parameters to the device 206. In accordance with an aspect, both of the devices 206, 208 consider the parameters to decide whether the data service should be initiated for a desirable overall experience, given the needs of the requesting device 206 and service providing device 208 in view of the measured parameters. Thus, in some configurations both devices may determine (223, 223′) whether to proceed with initiating the requested data service based on the measured parameters. In some configurations, the device 208 may independently make a decision to not provide the requested data service based on the current battery state of device 208 or based on other determined parameters. In some embodiments, the device 206 may, after having received the one or more parameters from the device 208, decide not to proceed with establishing a data connection for the requested service based on the reported parameters. In some configurations, the decision whether or not to initiate the data service may be jointly made by both the devices 206, 208.

From the perspective of the device 208, the decision may be based on what the measured values of the parameters indicate at the given time and whether the providing the data service may adversely affect the device's own condition/functioning. Thus in some configurations, the device 208 may compare the values corresponding to the determined one or more parameters with corresponding thresholds to determine if initiating the data service is feasible. In some configurations the device 208 may determine to operate as hotspot to provide the data service when at least two of the first, second and third parameters are greater than their respective thresholds. For example, in some configurations, the device 208 may decide to operate as the hotspot and provide the requested data service when a determined battery/charge level of the device 208, and available data speed, e.g., for data download from the network 202 (e.g., via the base station 204), are both above their respective thresholds. The threshold may be predetermined and may be set/changed by the user at any time. In some configurations the thresholds may be dynamic. In some, but not necessarily all configurations, the threshold for one or more parameters is set jointly by the devices 206, 208. From the perspective of the data service requesting device 206, the decision may be based on, for example, an estimation of the quality and/or duration of the expected data service from the device 208 given the measured parameters. For example, if the measured battery/charge level is low but above the threshold, the device 206 may decide not to pursue the data connection/service because the device 206 may anticipate that it may not be able to continuously receive the service, e.g., for a longer duration, given the low battery conditions of the device 208, even though the battery is slightly above a threshold level and the device 208 may be willing to initiate the data service. Thus, many different scenarios are possible.

For the purposes of discussion, consider that the device 206 after having considered the parameters, remains interested in the data service. In accordance with an aspect, the device 206 sends a message 224 to the device 208 indicating a continued interest in receiving the data service. Furthermore, consider for the purposes of discussion that upon consideration of the measured parameters and comparisons with thresholds, the device 208 decides to operate as the hotspot/service access point for the device 206. Accordingly, the device 208 requests (226) the data service on behalf of the device 206 from the base station 204, and obtains (228) the requested data for the device 206 from the base station 204. The data obtained from the base station 204 is then provided (230) to the device 206 over the data connection established between the devices 206, 208. The data may be provided over a wireless or wired connection. When wirelessly providing the data service, a variety of wireless and/or near field communication techniques and protocols may be used such as WiFi, Bluetooth, ZigBee etc.

In some configuration, the device 208 continues to measure the parameters, e.g., periodically, in accordance with a schedule, and/or in response to receiving renewed requests for continued data service, and updates stored parameter information in the device to reflect the updated values corresponding to the measured parameters. In various configurations, the device 208 sends updated report(s) to the device 206, e.g., while the data service is being provided to the device 206. The updated report(s) may be provided periodically, in accordance with a schedule, and/or in response to receiving renewed requests for continued data service. The updated measurements allow the device 208 to determine if the device 208 should continue providing the service to the device 206 or terminate the connection. For example, most recent measurements may indicate that the battery level is low and/or the device 208 is close to reaching a monthly data limit. Based on the updated measurements the device 208 may determine to discontinue providing the service and may inform the device 206 that device 208 can no longer provide the data service. Similarly, the updated report(s) may allow the device 206 to make determinations at various points in time if continuing to receive the data service remains desirable. For example, after a few minutes of receiving the data service at a satisfactory data speed, the device 206 may experience lower data speed and receive an updated report including updated parameters with a parameter for data speed (e.g., download and/or upload speed) indicating a lower data speed than an earlier data speed. Thus, in some such scenarios the device 206 may decide to no longer continue receiving the service, may terminate the data connection with the device 208, and stop receiving the data service. In some configurations, interactive prompt/updates may be provided to the users of the devices 206, 208, allowing the user to take an action to discontinue providing/receiving the data service based on such interactive updates of the measured values of the parameters. For example, when a user of the device 206 is in a data call using the data service provided by the device 208, and the updated parameters indicate that measured value(s) corresponding to one or more parameters is not optimal (although may be above a corresponding threshold), an interactive voice prompt alone or in combination with an another perceivable alert such vibration, message display, light flashing etc., may be provided on the device 206 (and on the device 208) allowing the user to end the call after informing the called/calling party that the call is going to end, rather than the call abruptly ending due to termination of data service because of the measured parameters being unfavorable for continued service. In some, but not all configurations, the updating of the parameters, the sending of updated report(s) and the decision making regarding continuing/discontinuing the data service may be performed automatically by the device 208 without a user intervention.

In the exemplary system 200 discussed above, a base station may also comprise, be implemented as, or known as an access point (AP), a NodeB, Radio Network Controller (RNC), eNodeB, Base Station Controller (BSC), Base Transceiver Station (BTS), Transceiver Function (TF), Radio Router, Radio Transceiver, connection point, or some other terminology. A communication device may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a communication device may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

A variety of processes and methods may be used for transmissions in the wireless communication system 200 between the base station 204 and the communication devices 206, 208. For example, signals may be sent and received between the base station 204 and the communication devices 206, 208 in accordance with OFDM/OFDMA techniques or using a variety of other wireless communication techniques and protocols, e.g., CDMA techniques.

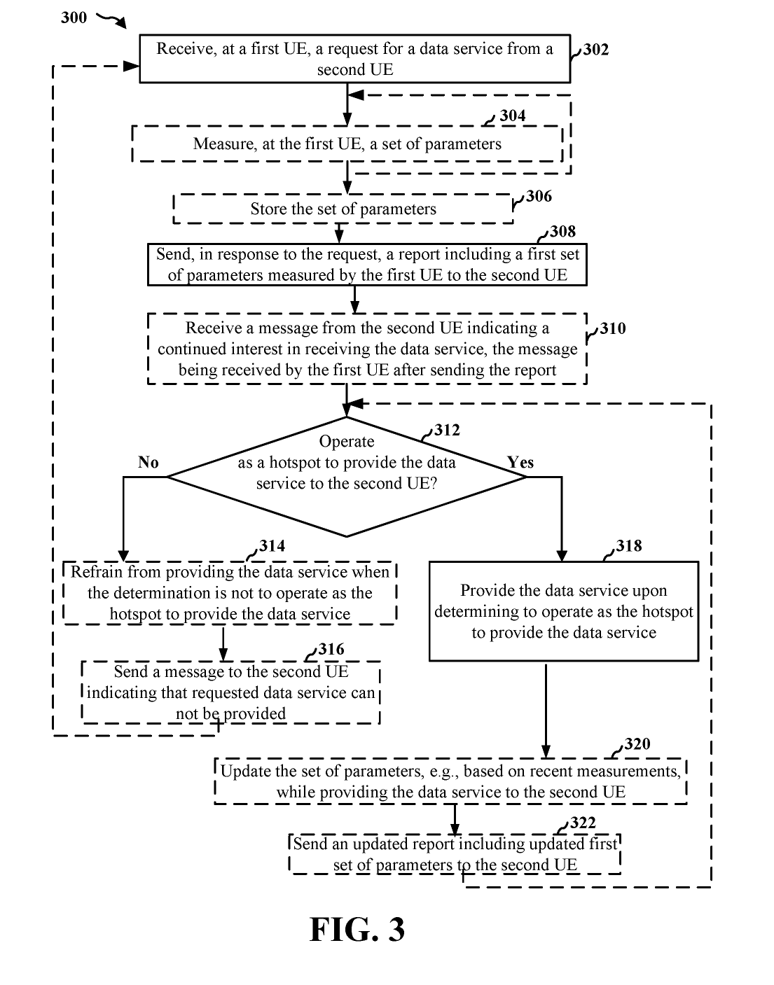

FIG. 3 illustrates a flowchart 300 of a method of wireless communication of a first UE. The first UE may be the communication device 208 which may provide a data service requested by a second UE, e.g., communication device 206. Some of the operations may be optional as represented by dashed/broken lines. At 302, the first UE receive a request for a data service from the second UE. For example, with reference to FIG. 2, the device 208 may receive the request (220) from the service requesting device 206 for assistance in receiving a data service. The request for data assistance from the second UE may be a request to enable a hotspot function of the first UE. At 304 the first UE measures, at the first UE, a set, e.g., a first set, of parameters. For example, again with reference to FIG. 2, the device 208 may measure (221) various parameters as discussed in detail above. The set of parameters may include, for example, a first parameter corresponding to a current battery condition, e.g., current battery/charge level, of the device 208, a second parameter corresponding to an expected data speed for the data service, and a third parameter corresponding available data limit for data services (e.g., indicating an amount of data that can be downloaded without exceeding a service plan data download limit). In some configurations, the first UE may measure the parameters in response to receiving the request for data service. At 306 the first UE stores, in a memory, the current measured set of parameters corresponding to the received request for data service from the second UE.

At 308, the first UE sends, in response to the request, a report including the first set of parameters measured by the first UE to the second UE. For example, again referring to FIG. 2, the device 208 sends (222) a report the first set of parameters to the device 206 in response to receiving the request for data service. The reported parameters may include one or more of the current battery battery/charge level of the device 208, an expected data speed for the data service, and available data limit for data service. In some configurations, the expected data speed may be proportional to the signal strength at the first UE. In some configurations, the report may include the measured signal strength (e.g., in terms of decibel (dB)) as an indication of the expected data speed. In some other configurations, the expected data speed may be indicated in terms of megabits per second (Mbps), or in terms of both dB and Mbps. As previously discussed, the second UE may consider the received parameters and make a determination, based on the measured values corresponding to the parameters, whether the second UE wants to initiate receiving the requested data service. If the second UE continues to be interested, then a continued interest message (224) may be sent by the second UE to the first UE. Assuming for the purposes of discussion that the second UE remains interested, in some configurations at 310 the first UE receives a message from the second UE indicating a continued interest in receiving the data service. In various embodiments, from a temporal perspective, the message is received by the first UE after sending the report including the first set of parameters.

At 312 the first device determines whether to operate as a hotspot/service access point to provide the data service to the second UE based on a second set of parameters measured by the first UE. The second set of parameters may be the same as the first set. In some other configurations, the second set of parameters may be different than the first set of parameters, or a subset of the first set. As discussed above with regard to FIG. 2, the first UE (device 208) may consider one or more of the measured parameters, compare the one or more parameters with their corresponding thresholds, and determine if it is feasible/desirable to operate as the hotspot and provide the requested data service to the second UE. In some configuration, the decision of whether to operate as a hotspot is further based on a message from the second UE indicating a continued interest in receiving the data service. For example, the continued interest message may be the message 224 from the device 206 after the device makes a determination to receive the requested service from its perspective based on the one or more parameters received in the set of parameters from the device 208. As should be appreciated, the sharing of measured parameters and consideration by both the first and second UE in a way provides a joint control to both devices with regard to initiating the data service. However in some configuration, the decision by the first UE whether or not to operate as the hotspot weighs more even if the second UE continues to be interested in the data service after considering the measured parameters. That is, if after consideration of the measured parameters, the second UE wants to initiate receiving the data service but the first UE determines not to operate as the hotspot, the data service will not be initiated at least in some embodiments. In some configurations, the second subset being considered includes the first, second and the third parameters discussed above. In some such configurations, the determination at 312 includes determining to operate as the hotspot to provide the data service when at least two of the first, second and third parameters are greater than respective thresholds for the at least two of the first, second and third parameters. For example, the first UE may determine to operate as the hotspot only if the measured battery/charge level is greater than a corresponding threshold level and the measured data speed (which may be proportional to measured signal strength) is above a corresponding threshold. In some other configurations, the determination at 312 includes determining to operate as the hotspot to provide the data service when each of the first, second and third parameters is greater than their corresponding thresholds, e.g., the first parameter is greater than a first threshold corresponding to a current battery level of the first UE, the second parameter is greater than a second threshold corresponding to a current data download speed through the first UE, and the third parameter is greater than a third threshold corresponding to available/remaining data limit allowed for the data services (e.g., amount of data that can be downloaded without exceeding a data plan limit). The determinations performed at 312 discussed above with regard to the first UE may be performed, in some configurations, by a user of the first UE, e.g., after considering the measured parameters and their comparison to the corresponding threshold which may be both output to the user, e.g., via a display or speaker of the first UE, allowing the user of the first UE to make a decision after thoughtful consideration of the parameters and condition of the first UE. In some other configurations, the determinations at 312 are performed by the first UE without user input based on the measured parameters and their comparison to the corresponding threshold.

Based on the determination at 312, the operation proceeds to 314 or 318. If at 312 the first UE decides, based on the second set of parameters (and optionally further based on the continued interest request) not to operate as the service access point for the second UE, then at 314 the first UE refrains from providing the data service. In some such configuration, at 316 the first UE sends a message to the second UE indicating that the requested data service cannot be provided at the given time. This may allow the second UE to find another hotspot for the given time and not keep requesting data services from the first UE repeatedly at that given time. The first UE may continue monitor for one or more other requests from other devices.

On the other hand if at 312 the first UE decides, to operate as the hotspot/service access point for the second UE, then at 318 the first UE starts providing the data service to the second UE, e.g., over a wireless or wired connection. The request for the data service may be a request for streaming a multimedia file, e.g., a video/audio of a song, a request to browse internet and open a webpage, a request to make a data call, e.g., voice over internet protocol (VOIP) call, etc. In some configurations providing the data service includes receiving data requested by the second UE, e.g., a media file, from a service provider network, e.g., through base station 204, and forwarding the data to the second UE over a local area network. The local area network may be, e.g., a wired or wireless local network. Next at 320, the first UE performs another measurement of the first set of parameters and updates the stored set of parameters (e.g., stored parameter values in the memory may be updated with the most current measured parameter values) to reflect the most current measurements, while the data service is being provided to the second UE. Next, at 322 the first UE sends an updated report with updated measured parameter values to the second UE. In some such configurations the updating the set of parameters and the sending the updated report is performed automatically by the first UE without a user intervention. In some configurations, the periodicity at which measurements are performed at the first UE changes with the length of time for which the data service continues to the second UE. For example, in some configurations when the data service continues to be provided for more than a predetermined amount of time, the measurements may be performed more frequently in some configurations. However, in another configuration, when the data service continues to be provided for more than the predetermined amount of time, the measurements may be performed less frequently. In some configurations the updated report is sent periodically or in accordance with a schedule set by the second UE. The first and the second UE may subsequently make determinations again, based on the updated parameters, whether the data service should continue and the process may repeat a number of times while the data service is being provided.

As should be appreciated, the methods discussed herein provide many benefits and enhancements in user experience while data sharing occurs. As discussed above, the overall user experience is improved, unexpected and/or unnoticed issues arising due to quick battery drain, data charges incurred and/or slower data speeds may be avoided by considering the various parameters and factors discussed above. Furthermore, the information regarding expected data speed is shared with the service requesting device such that the service requesting device may make an informed decision if continuing to receive the data service is desirable. Once the data service sharing is allowed to proceed, e.g., when agreed upon by both devices, there may be a minimum guarantee on the data speed. For example, in some configurations, after performing the measurements, the first UE may be able to determine that in the current conditions the first UE can support at least a certain data download speed for a certain amount of time. Based on such estimation, the first UE may send a minimum guaranteed data rate for a given period of time to the second UE. This may be sent in addition to and/or with the set of parameters.

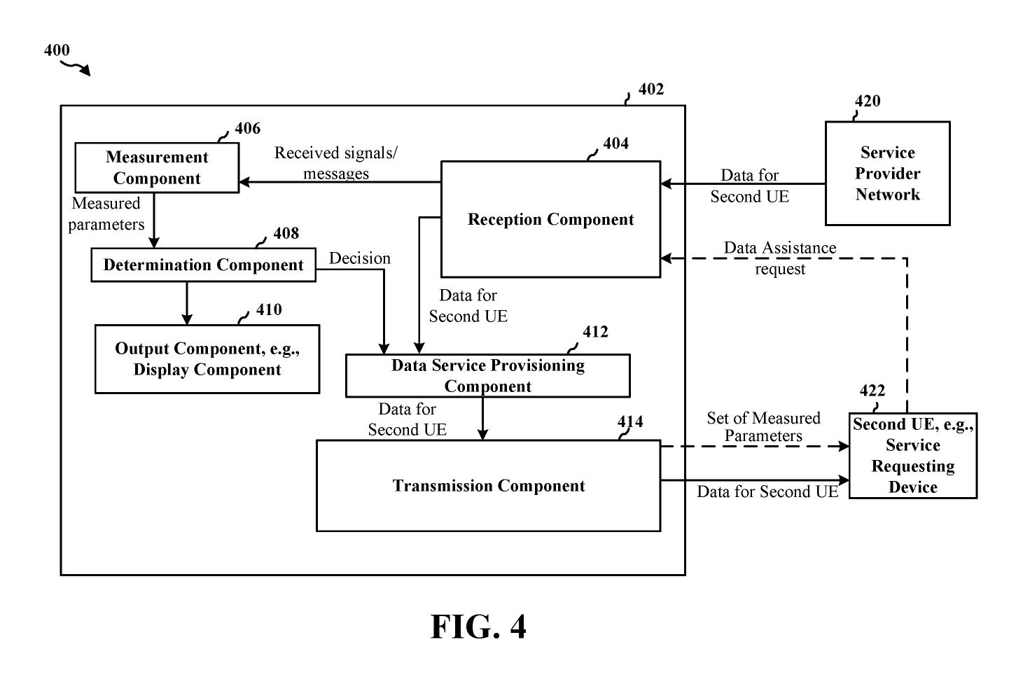

FIG. 4 is a conceptual data flow diagram 400 illustrating the data flow between different means/components in an exemplary apparatus 402. The apparatus may be a first UE, e.g., such as the communication device 208, implementing the method of flowchart 300. The apparatus 402 may include a reception component 404, a measurement component 406, a determination component 408, an output component 410, a data service provisioning/control component 412, and a transmission component 414.

The reception component 404 may be configured to receive and process messages and/or data from other devices such as the service provider network 420 and/or other UEs such as the second UE 422. For example, the reception component 404 may be configured to receive the request for data service/assistance, e.g., such as request 220 of FIG. 2, from the second UE 422 requesting the apparatus 402 for assistance in receiving a data service. The reception component 404 may be further configured to receive requested data, e.g., data packet corresponding to requested data service, from the network 420. In various embodiments, the reception component 404 may be further configured to receive signals from the network 420, e.g., from a serving base station of the network 420, based on which data speed at a given time may be measured and/or remaining data limit of the apparatus 402 may be determined. For example, the data speed may be determined based on a received signal strength of a downlink dedicated physical channel (downlink DPCH).

The measurement component 406 is configured to measure a first set of parameters. The set of parameters may include, for example, a first parameter corresponding to a current battery condition, e.g., current battery/charge level, of the device 208, a second parameter corresponding to an expected data speed for the data service, and a third parameter corresponding available data limit for data services. The measured first set of parameters may then be stored in a memory of the apparatus 402. In some configurations, the measurement component 406 is further configured to perform measurement on a periodic bases and/or in accordance with a schedule and update the first set of parameters and the second set of parameters (e.g., based on updated measurements) while the data service is being provided to the second UE.

The determination component 408 may be configured to determine whether to operate as a hotspot/service access point to provide the data service to the second UE 422 based on a second set of parameters measured by the apparatus 402. As previously discussed, the second set of parameters may be the same as the first set or a subset of the first set of parameters. In some configurations, the determination component 408 may be configured to make the determination further based on a request of continued interest from the second UE 422. As part of being configured to determine whether to operate as a hotspot/service access point to provide the data service to the second UE 422, the determination component 408 may be further configured to compare one or more of the measured parameters to their respective thresholds in order to make the determination. In some configurations the determination component 408 is configured to determine to operate as a hotspot to provide the data service when at least two of the first, second and third parameters are greater than their respective thresholds, e.g., determined in a comparison by the determination component 408. In some configurations the determination component 408 is configured to determine to operate as a hotspot to provide the data service when the first parameter is greater than a first threshold corresponding to a current battery level of the first UE, the second parameter is greater than a second threshold corresponding to a current data download speed through the first UE, and the third parameter is greater than a third threshold corresponding to available data limit for the data services. In some configurations the result of the determination, e.g., a decision, is provided to the data service provisioning/control component 412.

The output component 410 may include, e.g., a display component and/or an audio output component. The output component 410 may be configured to output the measured parameters, and optionally the result of comparison of the measured parameters values to the corresponding thresholds, to the user, e.g., as a visual message/prompt on the display screen which may be part of the output component 410 and/or as an audio message on a speaker. Such an output on the output component 410 may allow a user of the first UE to make a decision after based on the factors discussed above. In some such configurations where the user makes the determination whether the apparatus is to operate as a hotspot/service access point to provide the data service to the second UE 422, the user may provide the result of the determination as a user input, e.g., via a user interface of the apparatus which may be a keypad and/or touch screen of the apparatus. Such a user interface may be independent or included as part of the reception component 404 or the output (e.g., display) component 410. In some such configurations, the user input indicating the decision is provided to the data service provisioning/control component 412.

The data service provisioning/control component 412 may be configured to control the apparatus 402 to provide the data service upon a determination by the apparatus 402 to operate as the hotspot and provide the data service to the second UE 422. In providing the data service to the second UE 422, the data service provisioning/control component 412 may be configured to control the transmission component 414 to send data corresponding to the requested data service to the second UE 422. In some configurations, providing the data service includes receiving data requested by the second UE from the service provider network 420 and forwarding the data, e.g., via the transmission component 414, to the second UE 422, over a local area network. When a decision to not operate as the hotspot is made by the apparatus 402 based on various factors, e.g., based on the second set of parameters, as discussed in detail in previous sections, the data service provisioning/control component 412 may be further configured to refrain from providing the data service to the second UE.

The transmission component 414 may be configured to generate and transmit messages and/or information to other devices such as the service provider network 420 and the second UE 422. In some configurations, the transmission component 414 is configured to send, e.g., transmit, a report including a first set of parameters measured by the measurement component 406 to the second UE 422. The report including the parameters may be transmitted in response to the request for the data service from the second UE 422. In some configurations the transmission component may be further configured to send one or more additional reports, e.g., updated reports, including the updated first set of parameters measured by the apparatus to the second UE 422. In some configurations the updated reports may be sent periodically or in accordance with a schedule. In some configurations, the schedule may be set by the apparatus 402 and/or the second UE 422.

The apparatus may include additional components that perform each of the blocks of the algorithm in the aforementioned flowchart of FIG. 3. As such, each block in the aforementioned flowchart of FIG. 3 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

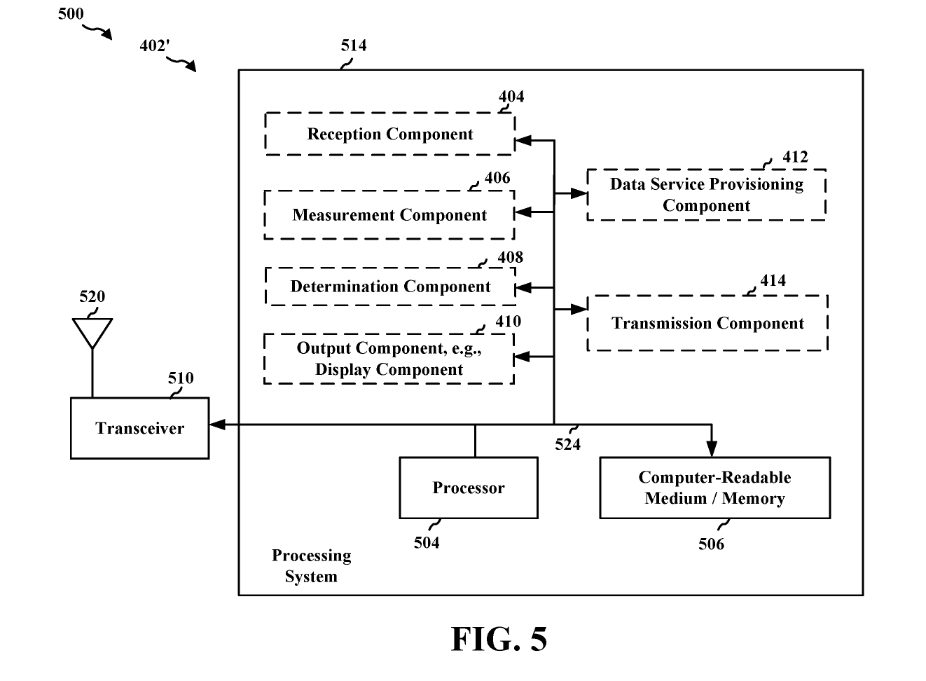

FIG. 5 is a diagram 500 illustrating an example of a hardware implementation for an apparatus 402′ employing a processing system 514. The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware components, represented by the processor 504, the components 404, 406, 408, 410, 412, 414, and the computer-readable medium/memory 506. The bus 524 may also link various other circuits such as timing sources, peripherals, voltage regulators, and power management circuits, which are well known in the art, and therefore, will not be described any further.

The processing system 514 may be coupled to a transceiver 510. The transceiver 510 is coupled to one or more antennas 520. The transceiver 510 provides a means for communicating with various other apparatus over a transmission medium. The transceiver 510 receives a signal from the one or more antennas 520, extracts information from the received signal, and provides the extracted information to the processing system 514, specifically the reception component 404. In addition, the transceiver 510 receives information from the processing system 514, specifically the transmission component 414, and based on the received information, generates a signal to be applied to the one or more antennas 520. The processing system 514 includes a processor 504 coupled to a computer-readable medium/memory 506. The processor 504 is responsible for general processing, including the execution of software stored on the computer-readable medium/memory 506. The software, when executed by the processor 504, causes the processing system 514 to perform the various functions described supra for any particular apparatus. The computer-readable medium/memory 506 may also be used for storing data that is manipulated by the processor 504 when executing software. The processing system 514 further includes at least one of the components 404, 406, 408, 410, 412, and 414. The components may be software components running in the processor 504, resident/stored in the computer-readable medium/memory 506, one or more hardware components coupled to the processor 504, or some combination thereof.

In one configuration, the apparatus 402/402′ may be a first UE including means for receiving a request for a data service from a second UE, and means for sending, in response to the request, a report including a first set of parameters measured by the first UE to the second UE. In some configurations, the apparatus 402/402′ further comprises means for determining whether to operate as a hotspot to provide the data service to the second UE based on a second set of parameters measured by the first UE, and means for providing the data service upon a determination to operate as the hotspot to provide the data service. In some configurations, the means for determining is configured to determine further based on a message from the second UE indicating a continued interest in receiving the data service, the message being received by the first UE after sending of the report. In some configurations, the means for providing the data service is configured to control the first UE to refrain from providing the data service when the determination based on the second set of parameters is not to operate as the hotspot.

In some configurations, the means for determining is configured to determine to operate as a hotspot to provide the data service when at least two of the first, second and third parameters are greater than respective thresholds for the at least two of the first, second and third parameters. In some configurations, the means for determining is configured to determine to operate as a hotspot to provide the data service when a measured value corresponding to a first parameter (e.g., current battery level) is greater than a first threshold corresponding to a current battery level of the first UE, a measured value corresponding to a second parameter (e.g., expected data download speed) is greater than a second threshold corresponding to a current data download speed through the first UE, and a measured value corresponding to a third parameter (e.g., available data limit) is greater than a third threshold corresponding to available data limit for the data services.

In some configurations, the apparatus 402/402′ further includes means for measuring the first set of parameters, and means for updating the first set of parameters and the second set of parameters while data service is provided to the second UE. The apparatus 402/402′ may further include means for outputting the one or more of the measured parameters. The means for outputting may include, for example, means for displaying the measured parameters, e.g., values corresponding to the parameters, and/or means for providing an audio output indicating the measured parameters. In some configurations, the means for sending is further configured to send an updated report including the updated first set of parameters measured by the first UE to the second UE. In some configurations, the means for sending is further configured to send the updated report periodically or in accordance with a schedule set by the second UE. In some configurations, the means for providing the data service is configured to receive data requested by the second UE from a service provider network and forward the data to the second UE over a local area network.

The aforementioned means may be one or more of the aforementioned components of the apparatus 402 and/or the processing system 514 of the apparatus 402′ configured to perform the functions recited by the aforementioned means. The processing system 514 may include a transmit processor, a receive processor, and a controller/processor. As such, in one configuration, the aforementioned means may be the transmit processor, the receive processor, and the controller/processor configured to perform the functions recited by the aforementioned means.

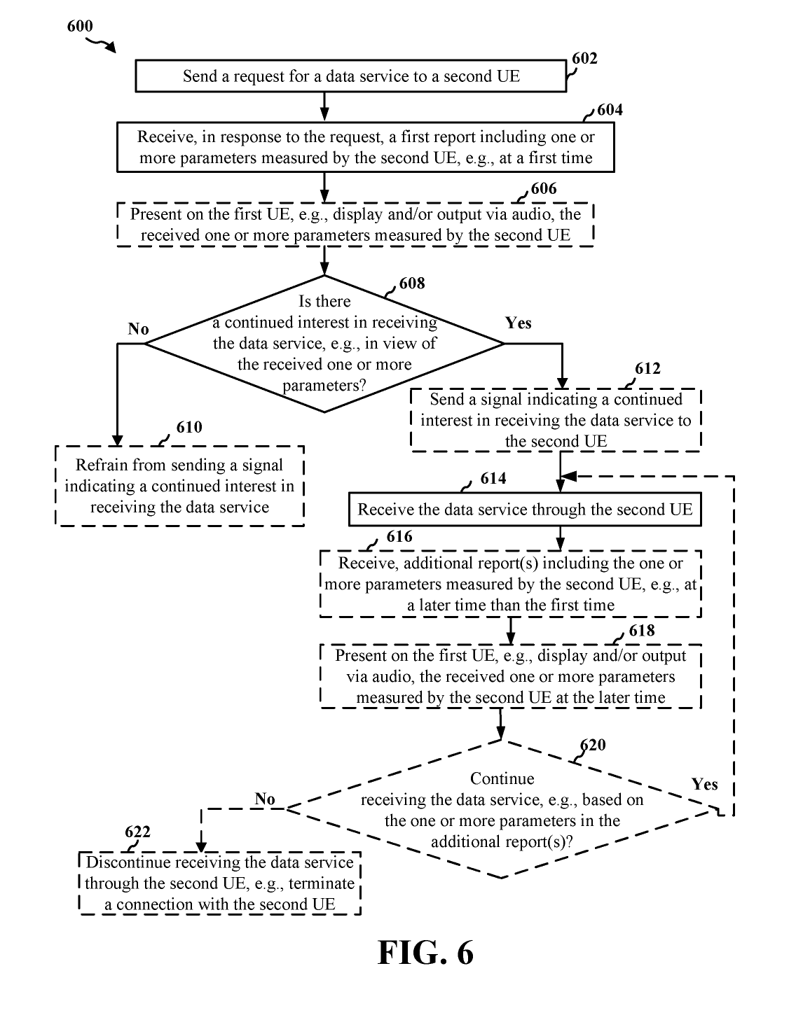

FIG. 6 illustrates a flowchart 600 of an exemplary method of wireless communication of a first UE. The first UE performing the method of flowchart 600 may be the communication device 206 of FIG. 2 requesting a data service assistance from the communication device 208. Some of the operations may be optional as represented by dashed/broken lines. At 602, the first UE sends a request for a data service to a second UE For example, with reference to FIG. 2, the communication device 206 may send the request (220) to the communication device 208, e.g., the second UE, for assistance in receiving a data service. At 604, the first UE receives, in response to the request, a first report including one or more parameters measured by the second UE. For example, again with reference to FIG. 2, the communication device 206 (first UE for the purposes of flowchart 600 discussion) may receive (221) a set of parameters, e.g., in a report, from the communication device 208 (second UE for the purposes of flowchart 600 discussion). The set of parameters in the received report may include, for example, a first parameter corresponding to a current battery condition, e.g., current battery/charge level, of the communication device 208, a second parameter corresponding to an expected data speed for the data service, and a third parameter corresponding available data limit for data services. In some configurations. The first UE may temporarily store the received one or more parameters in a memory. In some configurations, at 606 the first UE presents, on the first UE, the received one or more parameters measured by the second UE. The presenting may include at least one of displaying received measured values corresponding to the one or more parameters or outputting a voice message announcing the received measured values corresponding to the one or more parameters. While the one or more of the received parameters may be presented on the first UE in some configurations, e.g., allowing a user of the first UE to make a decision whether or not the user wants to receive the service given the current parameters, in various other configurations the decision making remains with the first UE without requiring any decision making or user input on the part of the user.

Next, at 608, the first UE determines based on the received one or more parameters, whether the first UE remains interested in receiving the requested data service. For example, given the current measurements of the parameters received from the second UE, e.g., one or more of the battery level of the second UE, expected data speed and the data limit, the first UE may decide whether the first UE is still interested in receiving the data service through the second UE. As previously discussed in greater detail with regard to FIGS. 2-3, the first UE (e.g., device 206) may compare the one or more parameters with their corresponding threshold levels (which may be set by a user of the first UE in some embodiments), and determine if it is feasible/desirable to receive the data service through the second UE given the result of the comparisons. For example, as part of operation at 608 the first UE may compare a received parameter indicating expected data download speed with an acceptable data download speed threshold (which may have been set by a user of the first UE) to make the determination. In some configurations, as part of the operation at 608, the first UE determines that the first UE is no longer interested in receiving the requested data service when at least one of the one or more parameters is below a corresponding threshold set for the at least one of the one or more parameters, and determines to remain interested in receiving the data service when at least one of the one or more parameters is above a corresponding threshold. In some other configurations, the first UE may no longer remain interested in receiving the data service if all the received parameters are below their corresponding thresholds. In some configurations, the threshold levels for the one or more parameters (that may be used in comparisons discussed above) are set by the first UE. In some configurations, the threshold levels for the one or more parameters are set by the second UE, e.g., the service providing UE. In some such embodiments, in addition to sharing the parameters, the second UE may also share the corresponding thresholds. In some other configurations, the threshold levels for the one or more parameters are set jointly by the first UE and the second UE, and thus agreed upon, e.g., prior to start of data sharing and/or during the data sharing.

Based on the determination at 608, the operation proceeds to 610 or 612. If at 608 the first UE decides, based on the received one or more parameters, that the first UE is no longer interested in receiving the data service, e.g., because one or more of the received one or more parameters are below their corresponding thresholds, then at 610 the first UE refrains from providing the data service. In some such configuration, at 316 the first UE sending an indication of continued interest to the second UE. In some configurations, if the second UE does not receive an indication of continued interest from the first UE within a predetermined time, the second UE assumes that the previously requested data service is no longer desired and may terminate a connection with the first UE. The first UE may then look for other available devices that may be operating as hotspots to provide data service assistance.

On the other hand, if at 608 it is determined that the first UE remains interested in receiving the requested data service through the second UE, then at 612, the first UE sends a signal indicating a continued interest in receiving the data service to the second UE upon determining that the first UE remains interested in receiving the requested data service. The signal indicating the continued interest is sent to the second UE, after receiving the report and prior to receiving the requested data service. Next at 614, the first UE receives (or continues to receive) the requested data service through the second UE. In some configurations, receiving the data service includes receiving the requested data, e.g., a media file, from the service provider network through the second UE. In some configuration the data service through the second UE is received over a non-cellular (non WWAN) network, e.g., over a wireless or wired connection. The local area network may be, e.g., a wired or wireless local network.

In some configurations, the one or more parameters included in the first report received by the first UE (at 604) are measured by the second UE at a first time. In some such configurations, at 616 the first UE receives additional report(s) including the one or more parameters measured by the second UE at a later time than the first time, e.g., with an individual additional report corresponding to a different subsequent time. For example, an additional report received by the first UE may be a second report including the one or more parameters measured by the second UE at a second time. In some configurations, at 618, the first UE presents, e.g., on a display or via a speaker of the first UE, the received one or more parameters in the received additional report. For example, a user of the first UE may be using the data service for a data call. The updated parameter values in a received additional report may indicate that the updated values have fallen below a threshold while the data service was being received by the first UE, e.g., during the data call. In such cases, it may be helpful to present the updated parameters on the first UE allowing the user to take an action, e.g., end the call, after informing the called/calling party that the call is going to end, rather than the call getting abruptly ended due to the first UE and/or the second UE terminating data service because of the measured parameters being unfavorable for continued service.

At 620, the first UE determines/decides, based on the updated parameters in the received additional report, whether or not to continue receiving the data service. If at 620, based on the updated parameter values it is decided to continue receiving the data service, then the first UE refrains from taking an action that would interrupt or terminate the data service being received and thus continues to receive the data service as represented in the flowchart by the loop back to 616. However, if at 620, based on the updated parameter values it is decided to not continue receiving the data service, then at 622 the first UE takes an action that would interrupt or terminate the data service being received. For example, the first UE may simply terminate the connection with the second UE over which the data service is being received and/or send a signal indicating that the data service should be terminated/discontinued.

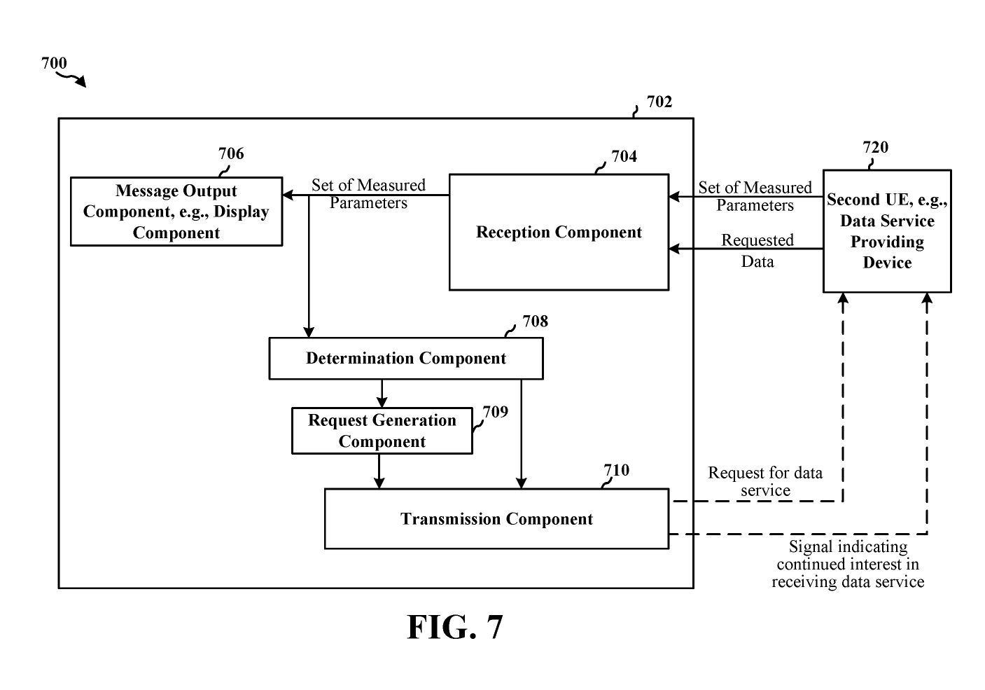

FIG. 7 is a conceptual data flow diagram 700 illustrating the data flow between different means/components in an exemplary apparatus 702. The apparatus may be a first UE implementing the method of flowchart 600, e.g., such as the communication device 206 that requests data assistance from the communication device 208. The apparatus 702 may include a reception component 704, an output component 706, a determination component 708, request generation component 709, and a transmission component 710.

The reception component 704 may be configured to receive and process messages and/or data from other devices such as the such as the second UE 720. The second UE may, e.g., the communication device 208 of FIG. 2 providing data service assistance to the requesting device 206 (first UE/apparatus 702). For example, in some configurations the reception component 704 may be configured to receive a set of parameters, e.g., including one or more parameters measured by the second UE 720, in a first report. The received parameters may include at least one of: a first parameter indicating a current battery condition, a second parameter indicating an expected data speed for the data service, or a third parameter indicating available data limit for data services. In some configurations, the reception component 704 may be further configured to receive additional report(s) including one or more of the parameters which have been measured at a later time than the measurements to which the parameters received in the first report correspond. Furthermore, the reception component 704 may be further configured to receive the data service, e.g., data corresponding to a requested data service.

The output component 706 may include, e.g., a display component and/or an audio output component such as a speaker. The output component 706 may be configured to output one or more of the received parameters, and optionally a result of comparison of the received parameters values to the corresponding thresholds, to a user of the apparatus 702, e.g., as a visual message/prompt on the display screen which may be part of the output component 410 and/or as an audio message on a speaker. The output component 706 may have the same or similar functionality as discussed with regard to component 410 of apparatus 402.

The determination component 708 may be configured to determine, based on the received one or more parameters, whether the apparatus 702 remains interested in receiving the requested data service, e.g., the apparatus is interested to initiate receiving a requested service in view of the received parameters. In various configurations, the determination component 708 may be configured to perform the determination based on the most updated/most recently received set of parameters. In some configurations, the determination component 708 may be further configured to determine, while the apparatus 702 is receiving the requested data service through the second UE 720, whether to continue receiving the data service based on the one or more parameters received in an additional report, e.g., received subsequent to the receipt of the first report. In various configurations the determination component 708 may be configured to perform the comparison of received parameters values to the corresponding threshold levels in order to make the determination in accordance with the features of the methods discussed above. For example, in some embodiments the determination component 708 may determine that the apparatus is no longer interested in receiving the requested data service when at least one of the one or more parameters is below a corresponding threshold set for the at least one of the one or more parameters. Based on a given determination, the determination component 708 may provide an input, e.g., a control signal, to the request generation component 709 and/or the transmission component 710 to take an action in accordance with the methods discussed above. For example, upon a determination that the apparatus 702 remains interested in receiving the requested data service, the determination component 708 may provide an input to the request generation component 709 to generate a signal indicating a continued interest in receiving the requested data service from the second UE 720, and further provide an input to the transmission component 710 to send the signal indicating the continued interest to the second UE 720. In some configurations, the determination component 708 may be further configured to control the apparatus 702 to refrain from sending the signal indicating a continued interest in receiving the data service upon determining that the first UE is no longer interested in receiving the requested data service. In some configurations, the determination component 708 may be further configured to control the apparatus 702 to discontinue receiving the data service through the second UE upon deciding not to continue receiving the data service.

The request generation component 709 may be configured to generate a request for data service assistance that is sent to the second UE 720, e.g., via the transmission component. In some embodiments, the request generation component 709 may be further configured to generate the signal indicating a continued interest in receiving the requested data service from the second UE 720 as discussed above. The transmission component 710 may be configured to transmit messages and/or information to other devices such as the second UE 720. In some configurations, the transmission component 710 is configured to send, e.g., transmit, the request for data service assistance to the second UE 720. The transmission component 710, in some embodiments, is further configured to send the signal indicating continued interest in receiving the data service.

The apparatus may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

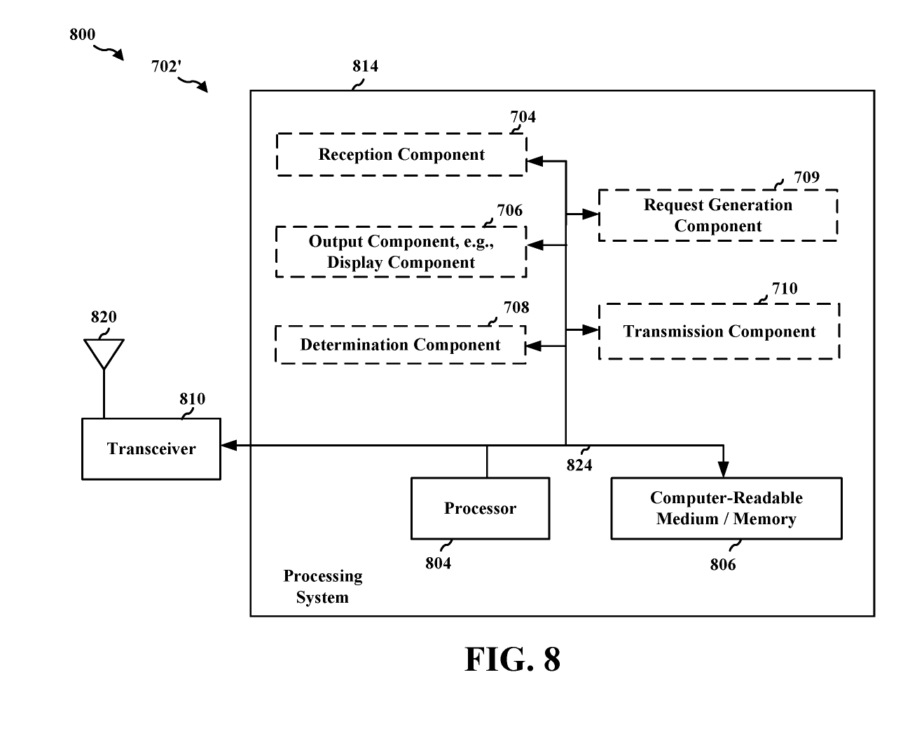

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 709, 710, and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 710, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708, 709, 710. The components may be software components running in the processor 804, resident/stored in the computer-readable medium/memory 806, one or more hardware components coupled to the processor 804, or some combination thereof.

In one configuration, the apparatus 702/702′ for wireless communication may be a first UE including means for sending a request for a data service to a second UE, and means for receiving a first report including one or more parameters measured by the second UE. The first report may be received in response to the request. In some configurations, the apparatus 702/702′ further includes means for determining, based on the one or more parameters, whether the first UE remains interested in receiving the requested data service, and means for receiving the requested data service through the second UE upon determining that the first UE remains interested in receiving the requested data service. The means for receiving a first report including one or more parameters, and the means for receiving the requested data service may be the same or different. In some configurations, the apparatus 702/702′ further includes means for sending a signal indicating a continued interest in receiving the data service to the second UE upon determining that the first UE remains interested in receiving the requested data service. The signal indicating the continued interest may be sent to the second UE, after receiving the report and prior to receiving the requested data service.

In some configurations, the means for determining is configured to determine that the first UE is no longer interested in receiving the requested data service when at least one of the one or more parameters is below a corresponding threshold set for the at least one of the one or more parameters. In some such configurations, the means for sending is configured to refrain from sending the signal indicating a continued interest in receiving the data service upon determining that the first UE is no longer interested in receiving the requested data service.

In some configurations, the means for receiving the first report is further configured to receive a second report including the one or more parameters measured by the second UE at a second time which is after the first time. In some configurations, the means for determining is further configured to decide whether the apparatus should continue receiving the data service based on the one or more parameters in the second report. In some configurations, the means for determining is further configured to control the apparatus to discontinue receiving the data service through the second UE upon deciding not to continue receiving the data service. In some embodiments the apparatus decides not to continue receiving the data service when the means for determining determine that at least one of the one or more parameters in the second report is below a corresponding threshold set for the at least one of the one or more parameters. In some configurations, the apparatus 702/702′ further includes means for presenting the received one or more parameters measured by the second UE, wherein the presenting includes at least one of displaying received measured values corresponding to the one or more parameters or outputting a voice message announcing the received measured values corresponding to the one or more parameters.

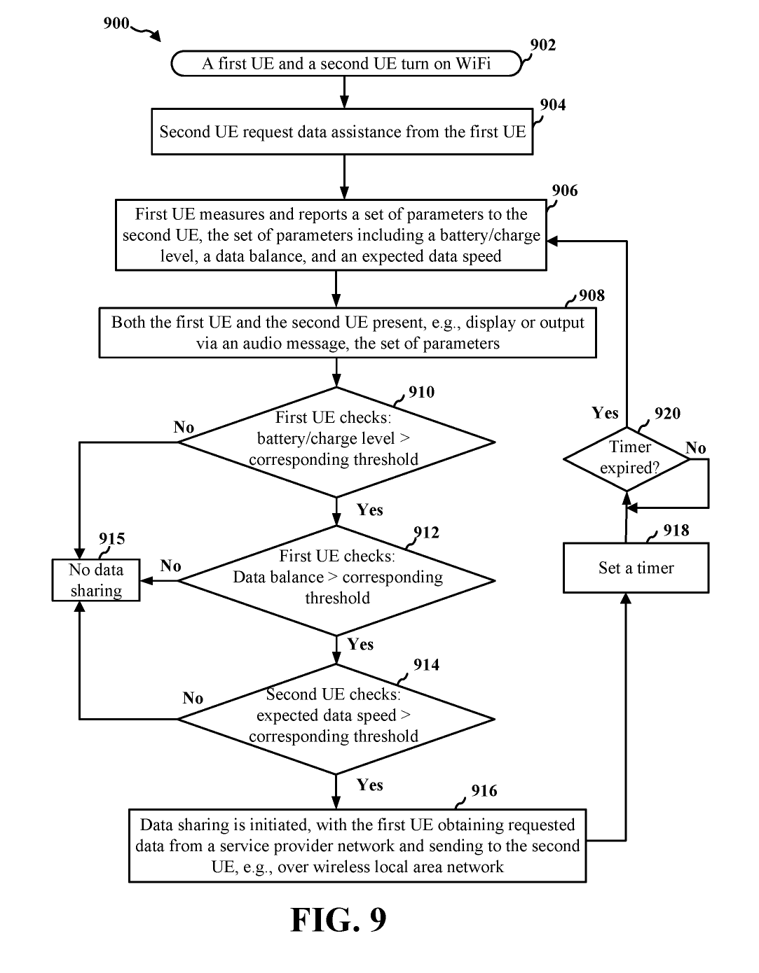

FIG. 9 is a flowchart 900 illustrating one specific example in which some aspects discussed above are used for data sharing between communication devices for improved user experience. In the illustrated flowchart 900, the first UE may provide a data service assistance to a second UE that has requested the data assistance. The first UE may be, e.g., communication device 208, and the second UE may be the communication device 206, of FIG. 2. At 902, the first and the second UEs turn on a local area or near field communication interface such as a WiFi interface to allow communication through WiFi. At 904, the second UE sends a request to the first UE for a data service. At 906, the first UE measures and reports a set of parameters to the second UE. The set of parameters may include a battery/charge level of the first UE, a data balance indicating data limit, e.g., remaining amount of data that can be downloaded in megabytes, and an expected data speed

At 908, both the first and the second UE may present one or more of the parameters, e.g., on their respective display screens or output as a voice message via respective audio speakers. As discussed earlier, both the first UE and the second UE consider the parameters before reaching an agreement on whether the data service should be initiated. At 910, the first UE may compare the battery/charge level (remaining battery level of the first UE) to a preconfigured threshold to determine if the measured battery/charge level is greater than the threshold (e.g., threshold may be 30% of the full charge level). If the battery/charge level is determined to be below the threshold, operation proceeds to 915 where a decision is made that data sharing should not proceed or be initiated. If the battery/charge level is determined to be greater than the threshold, the operation proceeds to 912. At 912, the first UE checks if another parameter, e.g., the remaining data balance, is greater than a corresponding threshold. If the remaining data balance is determined to be below the threshold, operation proceeds to 915 and data sharing is not initiated, otherwise operation proceeds to 914. At 914, the second UE checks if the expected data speed is greater than a corresponding threshold. If the expected data speed is determined to be below the threshold, operation proceeds to 915 and data sharing is not initiated. If the expected data speed is determined to be above the threshold, then at 916 the data sharing is initiated between the first UE and the second UE where the first UE obtains the requested data from a serviced provider network and sends to the second UE, e.g., over WiFi. At 918, the first UE may start a timer to allow reporting of the measured parameters (which may change over time) based on the timer. At 920, the first UE may check if the timer has expired. Upon expiration of the timer, the first UE may send an additional report including current (e.g., updated) measurements of the parameters to the second UE.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a first user equipment (UE), comprising:
receiving a request for a data service from a second UE;
sending, in response to the request, a report including a first set of parameters measured by the first UE to the second UE;
determining whether to operate as a hotspot to provide the data service to the second UE based on a second set of parameters measured by the first UE; and
providing the data service upon determining to operate as the hotspot to provide the data service.

2. The method of claim 1, wherein the determining is further based on a message from the second UE indicating a continued interest in receiving the data service, the message being received by the first UE after sending the report.

3. The method of claim 1, wherein the first set of parameters and the second set of parameters each include at least one of: a first parameter indicating a current battery condition, a second parameter indicating an expected data speed for the data service, or a third parameter indicating available data limit for data services.

4. The method of claim 1, further comprising:
refraining from providing the data service when the determination based on the second set of parameters is not to operate as the hotspot to provide the data service.

5. The method of claim 3, wherein the determining includes determining to operate as a hotspot to provide the data service when at least two of the first parameter, the second parameter and the third parameter are greater than a respective threshold for the at least two of the first parameter, the second parameter and the third parameter.

6. The method of claim 3, wherein the determining includes determining to operate as a hotspot to provide the data service when the first parameter is greater than a first threshold corresponding to a current battery level of the first UE, the second parameter is greater than a second threshold corresponding to a current data download speed through the first UE, and the third parameter is greater than a third threshold corresponding to a data limit for the data services.

7. The method of claim 1, further comprising:
updating the first set of parameters and the second set of parameters while providing the data service to the second UE; and
sending an updated report including an updated first set of parameters measured by the first UE to the second UE.

8. The method of claim 7, wherein the updating the first set of parameters and the sending the updated report is performed automatically by the first UE without a user intervention.

9. The method of claim 1, wherein providing the data service includes receiving data requested by the second UE from a service provider network and forwarding the data to the second UE over a local area network.

10. A first user equipment (UE), comprising:
at least one processor coupled to a memory, and configured to:
receive a request for a data service from a second UE;
send, in response to the request, a report including a first set of parameters measured by the first UE to the second UE;
determine whether to operate as a hotspot to provide the data service to the second UE based on a second set of parameters measured by the first UE; and
provide the data service upon a determination to operate as the hotspot to provide the data service.

11. The first UE of claim 10, wherein the at least one processor is further configured to determine whether to operate as the hotspot further based on a message from the second UE indicating a continued interest in receiving the data service, the message being received by the first UE after sending the report.

12. The first UE of claim 10, wherein the first set of parameters and the second set of parameters each include at least one of: a first parameter indicating a current battery condition, a second parameter indicating an expected data speed for the data service, or a third parameter indicating available data limit for data services.

13. The first UE of claim 10, wherein the at least one processor is further configured to refrain from providing the data service when the determination based on the second set of parameters is not to operate as the hotspot to provide the data service.

14. The first UE of claim 12, wherein the at least one processor is further configured to control the first UE to operate as a hotspot to provide the data service when at least two of the first parameter, the second parameter and the third parameter are greater than a respective threshold for the at least two of the first parameter, the second parameter and the third parameter.

15. The first UE of claim 10, wherein the at least one processor is further configured to:
update the first set of parameters and the second set of parameters while providing the data service to the second UE; and
send an updated report including an updated first set of parameters measured by the first UE to the second UE.

16. A method of wireless communication of a first user equipment (UE), comprising:
sending a request for a data service to a second UE;
receiving, in response to the request, a first report including one or more parameters measured by the second UE;
determining, based on the one or more parameters, whether the first UE remains interested in receiving the requested data service; and
receiving the requested data service through the second UE upon determining that the first UE remains interested in receiving the requested data service.

17. The method of claim 16, further comprising:
sending a signal indicating a continued interest in receiving the data service to the second UE upon determining that the first UE remains interested in receiving the requested data service, the signal indicating the continued interest being sent to the second UE, after receiving the first report and prior to receiving the requested data service.

18. The method of claim 17, wherein the determining includes determining that the first UE is no longer interested in receiving the requested data service when at least one of the one or more parameters is below a corresponding threshold set for the at least one of the one or more parameters, the method further comprising:
refraining from sending the signal indicating the continued interest in receiving the data service upon determining that the first UE is no longer interested in receiving the requested data service.

19. The method of claim 18, wherein the corresponding threshold for the at least one of the one or more parameters is set by the first UE or the second UE.

20. The method of claim 16, wherein the one or more parameters included in the first report are measured by the second UE at a first time, the method further comprising:
receiving a second report including the one or more parameters measured by the second UE at a second time which is after the first time;
deciding whether to continue receiving the data service based on the one or more parameters in the second report; and
discontinuing to receive the data service through the second UE upon deciding not to continue receiving the data service.

21. The method of claim 20, wherein the first UE decides not to continue receiving the data service when at least one of the one or more parameters in the second report is below a corresponding threshold set for the at least one of the one or more parameters.

22. The method of claim 16, wherein the one or more parameters include at least one of: a first parameter indicating a current battery condition, a second parameter indicating an expected data speed for the data service, or a third parameter indicating available data limit for data services.

23. The method of claim 16, further comprising:
presenting, on the first UE, the received one or more parameters measured by the second UE, wherein the presenting includes at least one of displaying received measured values corresponding to the one or more parameters or outputting a voice message announcing the received measured values corresponding to the one or more parameters.

24. A first user equipment (UE), comprising:
at least one processor coupled to a memory, and configured to:
send a request for a data service to a second UE;
receive, in response to the request, a first report including one or more parameters measured by the second UE;
determine, based on the one or more parameters, whether the first UE remains interested in receiving the requested data service; and
receive the requested data service through the second UE upon determining that the first UE remains interested in receiving the requested data service.

25. The first UE of claim 24, wherein the at least one processor is further configured to:
send a signal indicating a continued interest in receiving the data service to the second UE upon determining that the first UE remains interested in receiving the requested data service, the signal indicating the continued interest being sent to the second UE, after receiving the first report and prior to receiving the requested data service.

26. The first UE of claim 25, wherein the at least one processor is further configured to:
determine that the first UE is no longer interested in receiving the requested data service when at least one of the one or more parameters is below a corresponding threshold set for the at least one of the one or more parameters; and
refrain from sending the signal indicating the continued interest in receiving the data service upon determining that the first UE is no longer interested in receiving the requested data service.

27. The first UE of claim 26, wherein the corresponding threshold for the at least one of the one or more parameters is set by the first UE or the second UE.

28. The first UE of claim 24, wherein the one or more parameters included in the first report are measured by the second UE at a first time, the at least one processor further configured to:
receive a second report including the one or more parameters measured by the second UE at a second time which is after the first time;
decide whether to continue receiving the data service based on the one or more parameters in the second report; and
discontinue to receive the data service through the second UE upon deciding not to continue receiving the data service.

29. The first UE of claim 28, wherein the first UE decides not to continue receiving the data service when at least one of the one or more parameters in the second report is below a corresponding threshold set for the at least one of the one or more parameters.

30. The first UE of claim 24, further comprising:
presenting, on the first UE, the received one or more parameters measured by the second UE, wherein the presenting includes at least one of displaying received measured values corresponding to the one or more parameters or outputting a voice message announcing the received measured values corresponding to the one or more parameters.
